(19) United States
(12) Patent Application Publication
(10) Pub. No.: US 2017/0346562 A1
(43) Pub. Date: Nov. 30, 2017

(54) FREE SPACE OPTICAL COMMUNICATIONS SYSTEM

(71) Applicant: Intervention Technology Pty Ltd, Richmond, Victoria (AU)

(72) Inventor: Donald Victor Williams, Woodford (AU)

(21) Appl. No.: 15/540,256

(22) PCT Filed: Nov. 17, 2015
(86) PCT No.: PCT/IB2015/058907

§ 371 Date: Jun. 27, 2017

Related U.S. Application Data
(60) Provisional application No. 62/080,990, filed on Nov. 17, 2014.

(51) Int. Cl. H04B 10/116; H04B 10/80; H04B 10/114; H05B 33/08; H04B 10/112

(52) U.S. Cl. CPC H04B 10/116; H05B 33/0818; H04B 10/112; H04B 10/1149; H04B 10/803

(57) ABSTRACT

A lighting system comprises an excitor which drives at least one reactor. The reactor is an under-damped resonant circuit that includes a network of lighting elements in a reactive string and reactive components distributed among the lighting elements. These reactive components can regulate individual lighting elements. The lighting elements emit an AC luminous waveform which comprises a first phase and a second phase. Selected lighting elements can be modulated by a datastream. The modulated light moves through free-space to a receiving device.

### RELATED APPLICATIONS

This Application claims priority to U.S. Provisional Application No. 62/080,990, filed Nov. 17, 2014, which is incorporated herein by reference for all purposes. This Application is related to PCT Application No. PCT/US12/72253 filed 31 Dec. 2012, published as WO2013/102183 A1 on 4 Jul. 2013, which is incorporated herein by reference for all purposes. PCT Application No. PCT/US12/72253 is a parent application of U.S. Pat. No. 9,144,122 B2.

### FIELD OF THE INVENTION

One or more embodiments of the present invention relates to systems and methods for free-space optical communications using reactive strings.

### BACKGROUND

Free-space optical communication (FSOC) systems have been used for millennia. Reflected solar light can be directed by moving any reflective surface. Signal fires are another example of free-space optical communications. In modern times, electrically powered light sources have been used for FSOC. Alexander Graham Bell first transmitted sound over a beam of light in 1880. Lasers and LEDs were adapted to FSOC as they became available, and have also been used to inject modulated light into optical fibres. Point-to-point FSOC can be advantageous, because it is difficult to intercept, and eavesdropping on transmitted data can be difficult or impossible.

Much of the focus of FSOC system development was for such point-to-point communications over extended distances, and the interest in such systems has largely waned as optical fibres proved to provide a more commercially attractive implementation. Short-range, low bandwidth communications have, however, become commonplace in the form of infrared FSOC between hand-held remote controls and various consumer electronic devices (for example televisions, video and audio devices).

FSOC systems have also been proposed as an alternative to radio-frequency wireless data communications systems. FSOC has the potential of providing short-range broadband communications that do not require any RF frequency band allocation (which is becoming saturated) and can replace or supplement current WIFI communications systems. For example, Haas et al. (PCT Application Publication No. WO2011/003393 A1) disclose an LED-based FSOC system that can provide broadband local data communications.

### SUMMARY OF THE INVENTION

A free space optical communications system (FSOC) is built on a lighting platform including an excitor (an electrical waveform generator) and a reactor (a resonant circuit). The resonant circuit (“reactive string(s)”) comprises a plurality of reactive components and a plurality of lighting elements as LEDs. The excitor is configured to drive the resonant circuit which is under-damped and generally high-Q. The electrical waveform generator generates an AC voltage waveform at a frequency between about 10 kHz and about 100 MHz. Reactive components (e.g., capacitors) are distributed among the lighting elements such that they passively determine the power in individual lighting elements. The lighting elements emit an AC luminous waveform characterised by two phases: one which generally provides area illumination and one which is generally dark. Bidirectional FSOC can be provided between the lighting elements in the resonant circuit and emitter/detector pairs in a user device. Communication is possible during either phase, although communication during the dark epoch can be advantageous for improved signal-to-noise at high bandwidth. LEDs can be used as uplink detectors, or separate photodiode detectors can be added to one or more reactive strings. A datastream can modulate an entire string or individual elements within a string. Modulation of individual elements can be effected using variable reactive elements such as SAW devices or piezoelectric devices.

Generally, the datastream modulates a carrier frequency that is widely separated from the frequency of the illumination voltage waveform. Multiple reactive strings can operate at separate carrier frequencies and/or separate colours as well. Individual reactive strings can also include lighting elements of mixed type. Power and/or datastream waveforms at distinct carrier frequencies can be transmitted over a common two-wire bus. Internal system communications to controls and sensors can similarly be implemented over a distinct frequency band on the same bus.

Large networks can be configured as lossy transmission lines whereby “impulsive” sections comprising a set of parallel reactive strings are separated by additional reactive components such that a small phase shift exists between sections. A lossy transmission line topology allows data and/or additional power to be injected at intervals along the line. Arbitrary line lengths can be implemented.

Reactive strings can also be used to implement a variety of sensing functions, whereby either the LEDs or capacitors within a string implement a sensor transduction effect. Both individual sensor functions and collective (e.g., phased array) detection methods can be implemented.

### BRIEF DESCRIPTION OF THE DRAWINGS

FIG. 1 shows a lighting system comprising an excitor driving a reactive string.

FIG. 2 shows an exemplary reactive string including a lighting element modulated by a datastream.

FIG. 3 shows dark epochs within an illumination waveform.

FIG. 4 shows an exemplary distribution of frequency bands within an FSOC system.

FIG. 5 shows a reactive string configured as a lossy transmission line.

FIG. 6 shows one embodiment of periodic current injection into a lossy transmission line.

FIG. 7 shows a second embodiment of periodic current injection into a lossy transmission line.

FIG. 8 shows LEDs in a lossy transmission line used to determine position by phased array methods.

### DETAILED DESCRIPTION

Before the present invention is described in detail, it is to be understood that unless otherwise indicated this invention is not limited to specific circuits, lighting elements, or types of lighting elements. Any lighting system comprising a plurality of lighting elements can be beneficially driven using the circuitry described herein provided only that the lighting element can represent a “real” impedance (as opposed to a reactance or “imaginary” impedance) in an electrical circuit. It is also to be understood that the terminology used herein is for the purpose of describing particular embodiments only and is not intended to limit the scope of the present invention. Typical examples are described using LEDs as exemplary embodiments, but other lighting elements can also be used. Similarly, exemplary embodiments are described for use with indoor area lighting, but other embodiments can be used with outdoor lighting for streets, parking areas, stadiums, and the like. Optical communications systems can be provided via the lighting systems described herein.

It must be noted that as used herein and in the claims, the singular forms “a,” “and” and “the” include plural referents unless the context clearly dictates otherwise. Thus, for example, reference to “an LED” includes two or more LEDs, reference to “a reactive string” includes two or more reactive strings, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. The term “about” generally refers to±10% of a stated value. The term “substantially all” generally refers to an amount greater than 95% of the total possible amount.

### Definitions:

As used herein, the term “light emitting diode” or “LED” refers to a semiconductor diode which emits light when electrical current is passed through a forward-biased diode. Any type of LED can be used including devices emitting light at any available wavelength, luminosity, or input power. Any available semiconductor materials can be used, and any available package design can be used provided that appropriate electrical connections to the “excitor” can be made, and an appropriate “reactor” can be configured. Packaged LEDs may further comprise a local or remote phosphor, affecting the “colour” of the final emitted light, although the presence or absence of a phosphor is not material to the electrical characteristics of an LED. LEDs can be provided as fully packaged devices including phosphors, optional diffuser or lenses, and optional leads. Multiple LED junctions can be packaged together as either multiple dice in a single package or multiple junctions on a single die or any combination thereof.

As used herein, the term “steering diode” refers to a diode not used to emit light but only to direct current flow in specific pathways.

As used herein, the term “excitor” refers to a circuit which converts a source of electrical energy to an AC voltage source with a voltage and frequency suitable to drive a “reactor.”

As used herein, the term “reactor” refers to a network or array of lighting elements and reactive components which comprises a resonant circuit.

As used herein, the term “lighting element” refers to any component that emits visible light, either directly (e.g., incandescent bulbs, arc lamps, visible-light LEDs) or indirectly (e.g., fluorescent lamps, LEDs with phosphors). Lighting elements also include organic LEDs (OLEDs), quantum dots, microcavity plasma lamps, electroluminescent devices, and any element that can convert electrical current to visible light.

As used herein, the term “reactive component” refers to an electronic component which has little or no real impedance (i.e., resistance) but has significant imaginary impedance (i.e., reactance in the form of inductance and or capacitance). Reactive components are generally devices sold as capacitors, inductors, transformers, and the like intended to add capacitance and/or inductance to a circuit, but not significant resistance.

As used herein, the term “reactive string” refers to a reactor comprising a plurality of cells each comprising lighting elements and reactive components. A reactive string may optionally include current-steering diodes, but it contains no other semiconductor devices and no power dissipating devices other than the lighting elements themselves. A network comprising one or more reactive strings can be referred to as an “RSSL” network, where RSSL is short for “reactive strings for solid-state lighting.”

As used herein, the term “resonant circuit” refers to a circuit which has a natural oscillating frequency and is intended to be driven close to resonance or is used “under-damped,” whereby any energy absorption by resistance in the circuit (such as that provided by an LED) is insufficient to suppress oscillation; i.e., the circuit will continue to “ring” or oscillate for at least one cycle when no longer driven.

As used herein, the term “quality factor” or “Q” is used to characterise the damping of a resonant system. Q also describes the sharpness of the resonance. It is defined by Q=2π (energy stored)/(energy dissipated per cycle). It can also be calculated as Q=ω₀/Δω, where ω₀ is the resonant frequency and Δω is the half width of the power spectrum, also called the “bandwidth” of the resonance. An under-damped resonant circuit exhibiting voltage or current magnification has Q>1.

As used herein, the term “current utility ratio” (CUR) refers to the ratio of root mean square (rms) current passing through the lighting elements in a reactor to the total rms current supplied to the reactor. The CUR is generally less than 1 in a reactive string, because bypass elements such as capacitors are placed parallel to lighting elements.

As used herein, the terms “strike voltage” and “breakover voltage” (V_{b}) are interchangeable and refer to the voltage above which a particular network of devices starts to conduct and draw non-negligible current. If the network of devices consists of a single LED, the term “forward voltage” (V_{frwd}) is synonymous.

As used herein, the term “array” refers to arrangements of pluralities of connected elements having any dimension, for example, two-dimensional arrays, one-dimensional (linear) configurations, as well as configurations that can be construed as having three or more dimensions. For example, a 200-LED array used as a fluorescent tube replacement is commonly configured as an “array” of 10 “columns” with 20 LEDs in each column where each column is driven at a common voltage by a constant current power supply. Other terms such as multi-string, parallel-string, and multi-column are all taken to be synonymous to the term “array” herein.

As used herein the term “regulated” refers to control of a particular electrical parameter (such as voltage, current, or power) in the presence of a changing environment. Control does not mean there is no change in the value of the parameter, but rather that any change is functionally insignificant in the local context. The device continues to operate within the manufacturer's specified “safe operating area” (SOA).

Embodiments of the present invention generally implement free-space optical communications using the drivers for arrays of lighting elements described in PCT Application No. PCT/US12/72253, incorporated herein by reference. These systems provide regulated power to individual lighting elements arranged in array configurations interspersed with reactive components. These arrays are referred to as “reactive strings.” Among the topologies of reactive strings, there are embodiments which provide three advantageous properties: (1) the current/voltage regulation is sufficiently robust that some level of element failure can be tolerated, and remaining functional elements continue to function with useful output, (2) the array itself may be an essential component of the power transforming process (e.g., AC to DC), and (3) currents and voltages to individual elements in the array are regulated in a way that is tolerant of device variability and manufacturing tolerances.

Reactive strings can have a variety of attributes. In some embodiments, the reactive strings have constant luminance, whereby when some lighting elements fail, the current to the remaining lighting elements is increased to provide constant luminance. The current to the remaining elements changes only minimally. This behaviour is a consequence of appropriate selection of the interspersed reactive components together with a topology and drive system that puts the lighting elements and reactive components into a resonant tank circuit operating near resonance. If the topology is initially configured for maximum luminosity, then the remaining elements continue to operate at the same current for maximum residual luminosity. Light output can be maximised and heat dissipation can be minimised.

A “reactor” comprises the reactive strings and also at least one inductor and one capacitor to form a resonating circuit in which substantially all power dissipation occurs in the lighting elements. The additional control elements can be passive reactive components having minimal loss. No dissipative elements such as resistors are required to adjust individual lighting element currents. Further, the resonant behaviour provides pseudo-regulation of the current to regulate light output. The role of inductors and capacitors can generally be interchanged in reactive strings. For the sake of concreteness, embodiments herein generally use capacitors as the reactive elements in individual cells, each of which includes at least one light-emitting element, and a smaller number of inductors and/or transformers are used to complete resonant tank circuits, implement voltage level conversion, and separation elements of a “lossy-transmission line” (described in greater detail below). However, embodiments with inductors in each cell and a smaller number of capacitors are also possible.

The LED excitation uses AC currents, and the distribution of power among the LED population is managed using reactive components. Overall reliability is improved, power supply component count is minimised, and the overall system cost can be lower than conventional DC-driven systems. The autonomous or self-regulation of the power distribution results in a system which is less complex and safer for use in human living spaces, because the high operating frequencies are neurologically benign, and the passive reactor components replace the proliferation of active power supplies in typical installations. In some embodiments, a single excitor can be used to drive multiple reactors. For example, a single excitor in a distribution panel could drive all the reactors required to illuminate a typical home.

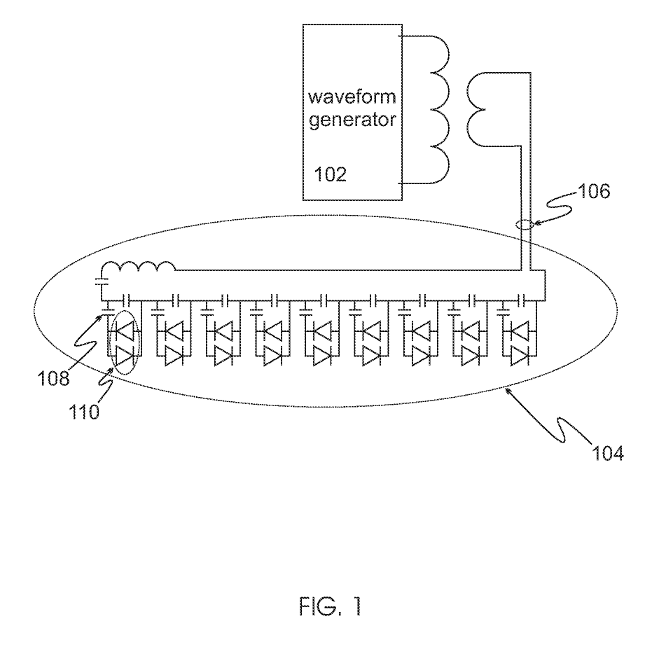

Reactive string systems integrate an “excitor” 102 with one or more resonant “reactors” 104 as shown in FIG. 1. The excitor itself does not resonate but supplies AC excitor power at constant frequency and voltage to the reactors via a two wire bus 106. Embodiments of the present invention do not need to fully rectify the voltage.

The distribution of power to reactive strings uses AC voltages, and data signals can be superimposed on the power distribution lines. A data signal can be transmitted using any modulation technique known in the art. For example, amplitude modulation (AM), frequency modulation (FM), frequency shift keying (FSK), or phase modulation (PM) can be applied to a carrier wave, which can be at the same or a different frequency from that of the power voltage waveform. Depending on the choice of carrier frequency and carrier bandwidth, available data bandwidth can vary as is known in the art. Various techniques can be used to increase the useful bandwidth, for example, by combining amplitude and phase modulation (“quadrature amplitude modulation” or QAM). FSOC systems also enable optical frequency division multiplexing (OFDM) whereby the optical spectrum is divided into discrete communications “channels” (colours) each of which can provide an independent frequency-locked data channel that can be separately modulated. All of these known modulation techniques can be used individually or in combination in embodiments of the present invention.

In some embodiments, data signals superimposed on the power distribution lines are used for internal communications within a lighting system. Lighting systems can include controls and sensors. Some controls can provide manual functions such as local switching and dimming functions. Some lighting systems have digital control systems, either instead of or in addition to manual controls. In these systems, a digital control system can communicate bidirectionally with a set of sensors and controls. Sensors can be provided to sense light levels (both daylight and illumination light provided by the system) as well as motion and presence. Controls can set light levels and turn lights on and off. For example, dimming can be implemented using a programmable variable inductor such as a magnetic amplifier, wherein a small control current modulates a magnetic core which affects the inductance of a secondary coil on the same core.

Most generally, the digital control system can communicate with any sensors and controls co-located with the lighting system. Such sensors and controls can be related to other building functions such and heating and cooling, security, window controls, blinds or shades, and so on. The digital control system can further be provided with a connection to a local communications network (intranet) and/or to the internet. Because of the high frequency of the power bus, ancillary devices for light monitoring or dimming only need a small transformer to provide a useful power supply for small microprocessor or embedded systems. Thus, an RSSL lighting system is ideally suited for integration of instrumentation and control to add a lighting system to the “Internet of Things” (IoT).

Embodiments of the present invention can also provide a novel link between computing devices (such as desktop or laptop computers, tablet computers, or smart phones) and the network. If another link also exists (for example, wired ethernet or WIFI), devices so connected can also be used to control lighting system functions via the digital control system. For example, embodiments of the present invention can provide both local FSOC connections to a network and simultaneously control of lighting network functions from devices located outside the communications range of the FSOC capability; in principle, any network-connected device can provide lighting network control, although in some embodiments lighting network control can be restricted to local devices or selected authorised devices.

A portable computing device can be configured to connect to the local FSOC system when it is available, and to use other communications means when the local FSOC system is out of range. Since FSOC is generally limited in range (for example, limited to individual rooms within a building), a system can also include multiple communications “cells” (FSOC cells) that correspond to the effective range of a given optical transmitter and receiver. As a user moves around a building, for example, communications can shift from one FSOC cell to another as for cellular telephone systems operating over radio-frequency channels. When the user leaves the building, their communication can shift automatically to another mode (such as an RF link to a cellular telephone network or WIFI network) as available.

As described in PCT Application No. PCT Application No. PCT/US12/72253, the reactive strings operate advantageously near a high-Q resonance. The Q of the resonance determines a bandwidth which limits the rate at which data that can be transmitted by modulating the power waveform for that frequency. In some embodiments, the data rate can be increased by choosing a power carrier waveform at higher frequency, since, for the same Q, a higher frequency will provide a higher absolute bandwidth. If the data bandwidth requirements are modest (as, for example, in systems where the data are used only for internal system communications), then a data transmission method that modulates the power waveform frequency can be useful. Note that, while data can be extracted at any location along a power bus, the data are inherently superimposed on the reactive string itself, and the data signal modulates the lighting elements. The data modulation does not affect the average luminous output of the LEDs, and cannot be perceived by the human visual system as long as the carrier frequency itself is greater than about 50 Hz. (The light flux waveform is at twice the electrical power waveform frequency, so a carrier frequency greater than 50 Hz produces a luminous waveform having a frequency greater than 100 Hz.) Typical reactive string systems operate at a minimum of about 10 kHz, and flicker is imperceptible.

Thus, in some embodiments, the lighting elements can provide both high power illumination and high signal-to-noise downlink transmitters into a FSOC cell, where the FSOC cell is defined by the area illuminated by the reactive strings driven from a particular power bus and operating at a particular power waveform frequency. Multiple FSOC cells can operate off a single two-wire power bus by superimposing multiple power waveforms at frequencies separated by an interval greater than the bandwidth of each reactive string resonance, such that the modulation side-bands do not overlap. Such separation is analogous to the separation between “channels” in radio or TV spectrum allocation: each reactive string is “tuned” to a particular channel and only responds to power and data transmitted at its assigned channel carrier frequency.

Data uplink requires a sensor system that can receive optical signals from devices located in a particular FSOC cell. Uplink sensors can be co-located with any convenient fixture within the FSOC cell. In some embodiments, uplink sensors are co-located with one or more luminaires. In some embodiments, uplink sensors are located in dimmer or switch control boxes. In some embodiments, uplink sensors can be implemented using sensors that also serve to monitor light levels (daylight, system illumination, or both). The uplink data (and light level data if shared) can be transmitted back to the digital control system over the same two-wire power bus that is used for power and downlink data transmission. Full duplex data transmission can be implemented, for example, by using separate carrier frequencies for uplink and downlink data transmission.

In some FSOC systems, much higher data bandwidths can be provided than can be easily achieved using the same lighting elements for both illumination and data downlink. To fully exploit the bandwidth potential of FSOC, it is advantageous to use high frequency carriers (e.g., 1 MHz to 10 GHz) and to exploit OFDM methods in addition. Reactive strings can be designed to operate at frequencies over 1 MHz, but it is also possible to separate the power carrier frequency from data carrier frequencies. Further, in some embodiments, the optical power required to achieve usable signal-to-noise ratio (SNR) for reliable data communications can be much less than that required for area illumination. This is the situation that typically applies for indoor installations.

In some embodiments the sensors for data uplink can be LEDs that are also used for illumination and/or data downlink. LEDs may not be optimised for use as light sensors, but in some applications they may nonetheless be usable.

In some embodiments, separate light emitters are provided for area illumination and data downlink. Light emitters for area illumination are typically selected and configured to provide an approximation to “white” light; i.e., the light emitters provide broad spectrum illumination in the visible spectrum or at least multi-spectral illumination that appears white to the human visual system. Light emitters for data downlink and uplink can be the same broad spectrum emitters, but they can also be narrow-band emitters. They can further be selected to emit at wavelengths not used for illumination. For example, data downlink/uplink emitter wavelengths can be infrared (IR) or near-UV. Such wavelength separation from the illumination wavelengths can improve data SNR by ensuring that the received optical data signal is not superimposed on a large background level that can introduce significant noise. Further, the inherent ability of reactive strings to correctly bias mixed types of LEDs and tolerate failures of individual LEDs within a string makes it easy to integrate UV and/or IR LEDs with white-light LEDs (or RGB arrays of LEDs). Lenses and filters can be incorporated as needed for particular system designs.

In some embodiments, the background level problem can be further reduced by time-division-multiplexing. A reactive string operating at maximum luminous output has a waveform approximating a haversine luminous waveform at twice the power carrier frequency: the current waveform is bidirectional with I=I₀ sin ωt; the light flux is strictly positive with φ=φ₀ haversin

$$2 ω t = {ϕ}_{0} \frac{1 - cos 2 ω t}{2} .$$

The distribution of power in reactive strings is achieved by reactive elements. A circulating current exists, and this circulating current is manifested in a “dark period” at the zero crossing of the LED in the string. The current used by a LED in the string as a proportion of the circulating current is referred to as the current utility ratio (CUR). As any dimming is effected by detuning the network (or individual reactive strings), this dark period is extended as a percentage of the period at the frequency of the detuned reactive string. This is an effective strategy during daylight for example when less lighting is required but data communications are in maximum demand. Regardless, the dark period is not perceived by the human visual system since it is a small fraction of a very short illumination waveform period.

To maximise SNR, it can be advantageous to include a small “off-interval” or “dark epoch” by using an appropriate dimming system and providing sufficient excess luminous capacity such that the maximum power setting would always have a design off-interval of, for example, at least 5-20%. Whether the off-interval is only momentary or a finite percentage of the luminous waveform period, it can be advantageous to transmit data only during or near the off-interval where there is a minimal background reflectance from the area illumination. A common problem with FSOC systems is that the relatively high intensity and variable colour of reflected light from walls, furnishings, etc. can represent a significant source of noise to a detector. By confining data transmission (both downlink and uplink) to a dark epoch, such reflections are entirely absent. There would be a data-rate penalty perhaps, but given the very broad potential bandwidth available, the data-rate penalty can be advantageously accepted in the interest of improved SNR at lower optical power for data transmission. Improved SNR further allows for increased baud rate and/or increased “symbol” size (number of discrete symbols that can be encoded at a single time). Lossy transmission line configurations as described below can be used to increase symbol width by using separate colours and/or phases in separate impulsive sections within a longer string.

Note that dark epochs are generally synchronous within at least selected portions of an RSSL network. All LEDs within a portion of the network containing only reactive elements of a single type (only capacitors or only inductors) operate synchronously with no internal phase shifts.

FSOC systems do not have fixed signal path length, and multipath reflections can introduce an additional source of noise as a result of unpredictable interference among data signals transmitted along a plurality of signal paths including multiple reflections from coloured objects within the FSOC cell. In some embodiments, excess channel capacity can be used to select a channel for a particular user that exhibits the least noise using techniques known in the communications arts (e.g., digital subscriber line (DSL) systems). Multipath noise can be further reduced using adaptive equalisation methods as are known in the communications arts. The equalisation can be advantageously performed during the dark periods where a FSOC cell reflectance spectrum can be accumulated by testing for noise from reflections at each available colour channel.

OFDM methods are well-known in the context of optical fibre communications. Multimode fibres can carry a plurality of optical communications channels. Laser light sources are used. Lasers typically have very narrow colour bandwidths (of order 1 nm), and channels can be closely spaced. However, for FSOC systems, LEDs are typically preferred as both cheaper and more easily able to provide uniform illumination of an area. LEDs typically have much broader colour bandwidth, generally in the range of 50 nm. In some embodiments, the colour bandwidth of an individual light emitter can be narrowed using an optical bandpass filter. Some loss in power conversion efficiency will occur, but a gain in the number of colour channels that can be used can be obtained.

In some embodiments, LED colour channels for data transmission can be selected from any available LED wavelengths (UV through visible to infrared). In some embodiments LED colour channels are selected that are outside the wavelength range used for area illumination (for example, UV and/or infrared, but not visible).

As described above, in some embodiments, data is transmitted by modulating one or more carrier frequencies that are different from any power transmission carrier waveform. In some embodiments, the power and data carrier waveforms can be transmitted over a single two-wire bus. In some embodiments, a plurality of twisted wire pairs or coaxial wires can be used. Different choices can be made depending on required current capacity, electromagnetic interference (EMI) considerations, and frequency of operation.

Where multiple carrier frequencies are transmitted over one two-wire bus, the individual carriers can be “picked off' using standard “tuners” (band-pass filters). Reactive strings can function directly as a band-pass filter, requiring no additional filter components. Data carriers may require specific tuning components to select a data stream. The demodulation from the signal on the two-wire bus uses resonance as in all tuners. Power is efficiently transferred and suitably terminated for both power and communication frequencies.

Lighting elements used for FSOC data transmission are modulated by a datastream. In some embodiments, the data transmission lighting elements are included in the same reactive strings as the lighting elements used for area lighting. In some embodiments, one or more separate reactive strings can be used to drive the data transmission lighting elements. As previously noted, the configuration of lighting elements, LEDs, dice, and individual LED junctions into strings is a matter of design convenience which can be used to minimise component count and cost and for the convenience of component mounting. Typically, elements are combined into single strings when they are co-located in a single luminaire or when they are to be switched on and off or dimmed as a group. The designer is free to mix and match types of lighting elements within a single string, since each cell within a string can be controlled in power by its own reactive element(s) (typically at least one capacitor or inductor). Reactive strings adapt automatically to LEDs having different Vfrwd within a single string; each cell is “self-biasing” in that the voltage drop across an LED adjusts automatically to provide the current set by the series capacitor.

Where a separate reactive string for each optical data channel is provided, the entire string can be modulated subject only to the limitation of the available bandwidth given the frequency and Q of the resonance of that reactive string. However, it is also possible to separately modulate individual lighting elements within a string. If such modulation occurs at a frequency that is outside the bandwidth of the power frequency resonance of the string itself, then the data modulation carrier waveform is self-terminated within the string and does not reflect back onto the power bus, maintaining high fidelity at the various carrier frequencies, free of reflections.

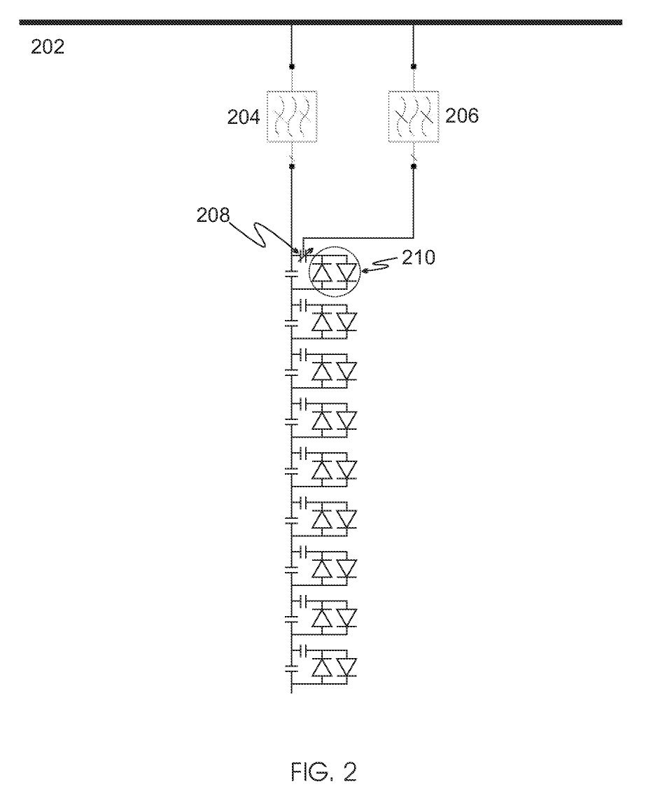

In a typical reactive string, a series capacitor (108 in FIG. 1) is used to set the peak current and biasing through one or more pairs of LEDs 110. This series capacitor provides a convenient location for data modulation. For example, if a series capacitor controls the current through a single pair of LEDs, then the light output from that pair of LEDs can be modulated by using a variable capacitance device 208 in place of (or in addition to) a fixed series capacitor as shown in FIG. 2. FIG. 2 shows a two-wire bus 202 carrying both a power carrier waveform and a data carrier waveform. Tuner 204 selects the power carrier waveform, and tuner 206 selects the data carrier waveform. Examples of circuit elements that can be modulated at high speed to implement a high-data-rate variable capacitor 208 include piezoelectric transducers and surface acoustic wave (SAW) transducers. LED pair 210 transmits data, the remaining LEDs in FIG. 2 are for illumination. Additional LED pairs could be separately modulated to provide additional data channels.

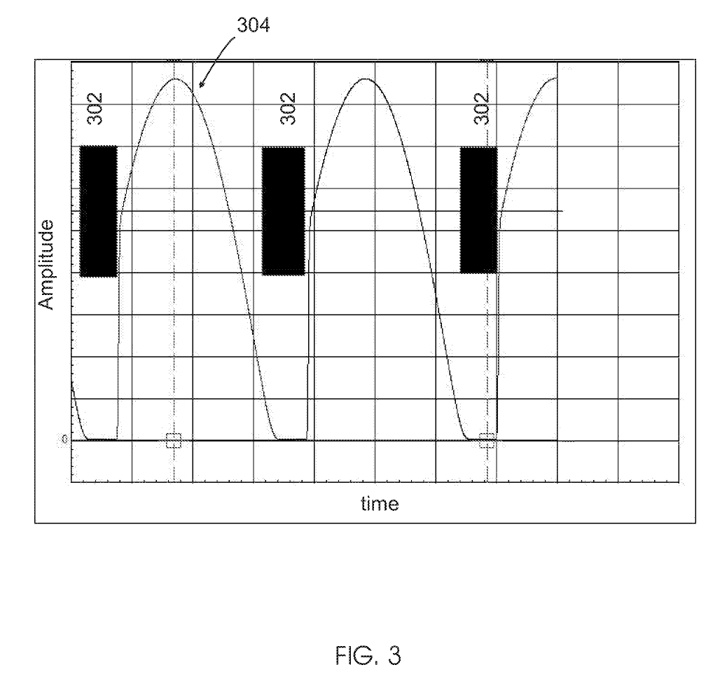

In some embodiments, separate reactive strings are used for illumination and data downlink/uplink. The separate reactive strings can be configured to operate at different carrier frequencies and/or at different colours. Typically, the clocks are synchronised such that data transmission can be confined to the dark epochs 302 in the illumination waveform 304 as shown in FIG. 3. An entire reactive string can function together as a data uplink sensor with data extracted (converted to an electrical signal) from a resonant node in a lossy transmission line configuration (see below).

Note that a topology where data is downlinked through LEDs that are distinct from illumination LEDs and use separate frequency bands allows data LED brightness to be independent of illumination LED brightness. Typically, the illumination LEDs are dimmed as desired using a resonance detuning method that is applicable to LEDs in a resonant string or portion thereof that responds to a power carrier frequency (e.g., 32 kHz). The dimming function does not interact with the data LED brightness, because the data LEDs are configured to operate at a data carrier frequency (e.g., 100 MHz) that has a non-overlapping power band with the power band of the power carrier frequency.

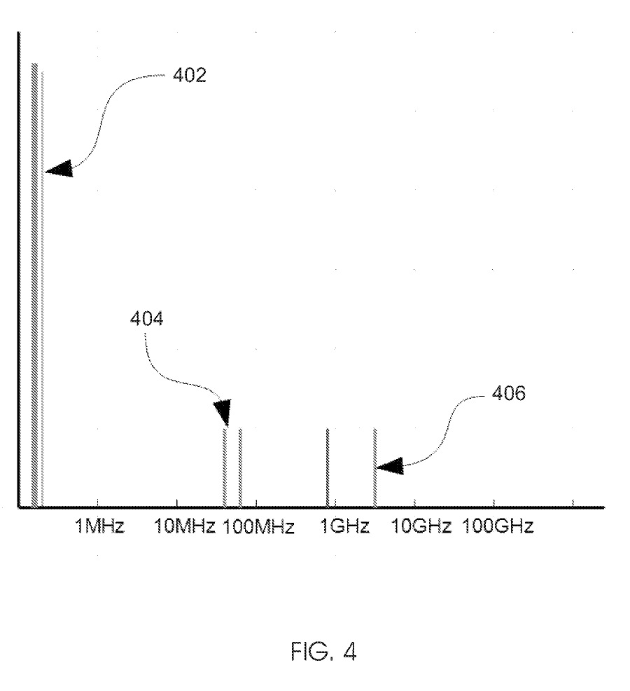

FIG. 4 shows an exemplary distribution of carrier frequencies. The power carrier frequency 402 is shown with an adjacent dimming signal bandwidth. Data channels for FSOC are shown in the 60-80 MHz range 404. Intercellular data transport among FSOC cells at multi-Gbps bit rates are shown in the frequency range 406. The injection loss in such modulation is the modulation of an extant bias current generating a time varying photo-density waveform established over a much longer time constant. As shown in FIG. 4, the injection impedance is low, because inside the resonant bias, the projection of the modulation signal is “impulsive” being carried from the neighbouring LEDs by capacitive coupling such that its energy is dissipated in the cell LEDs.

Alternatively, one can say that the modulation of the power frequency bias current “intra-string” is “differentiated.” The perturbation or reflectance back onto the bus is negligible due to the high inductance of the lower operating frequency power signal. Note that a power waveform carrier and a suitably up-shifted data modulation carrier current can coexist in the same string as long as the frequency bands for the two carriers are sufficiently widely separated. The dark period can be employed for equalisation of the space, alternate communications purpose, or to enhance SNR and increase baud rate. In a typical embodiment, where the data communications application is emphasised, the modulation carrier frequency can be much higher than the power waveform carrier frequency. A reactive string as a whole can have a resonant frequency and bandwidth compatible with the power waveform carrier frequency. At the same time, the higher frequency data modulation can be applied to an individual series capacitor within the string to further modulate the current through a single pair of LEDs within the string.

In some embodiments, the cells for reactive strings can comprise discrete LEDs and capacitors assembled onto one or more circuit boards. In some embodiments, individual cells can be fabricated as packaged devices, for example, as two LEDs and two capacitors in a single package with solderable pads or leads, or with a mechanical connector. Mechanical connectors can allow user replacement of a single packaged device. In some embodiments, a plurality of cells are fabricated into a single package. The number of leads or connections can vary from two for a string of a plurality of cells to two for each cell or any suitable combination. More leads can increase cost, but also increases flexibility to allow alternative arrangements of serial and parallel connections. In some embodiments, reactive strings can be implemented as hybrid circuits, whereby selected groups of components are mounted together as subassemblies that in turn are mounted onto a main circuit board.

In some embodiments, a reactive string can be implemented directly on a wafer such that an entire cell or a plurality of cells are present on a single die. Typically, capacitors are fabricated on a wafer between two metallisation layers as part of an LED fabrication process. After fabrication, a wafer can be diced as desired such that individual dice may contain entire cells or a plurality of cells. This is an extension of the “chip on board” (COB) methods of fabricating dice having multiple LED junctions, typically internally wired with particular connections. Multiple junction dice (for example, products originally designed for non-RSSL use) can also be used with external capacitors.

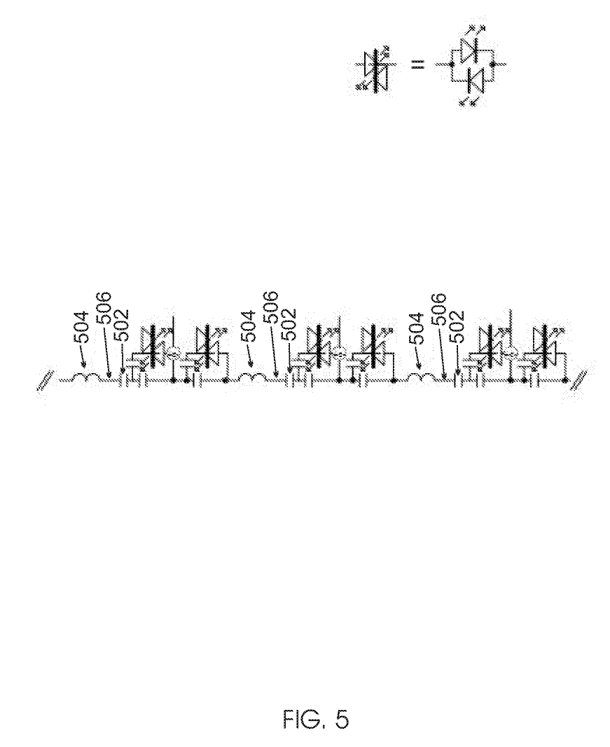

In some embodiments, a plurality of reactive strings are connected in series, separated by reactive elements such as a capacitor 502 and inductor 504 as illustrated in FIG. 5. A typical RSSL network comprises a plurality of cells each of which comprises LEDs together with series capacitors, Cₛₑᵣ and parallel capacitors Cₚₐᵣ. A complete resonant circuit includes an additional series capacitor C_{R} and a series inductor L_{R}. The additional series capacitor C_{R} provides design freedom to properly set the voltage across a particular potential population of individual cells within a reactive string, while appropriate values of Cₛₑᵣ can be used to individually bias each LED. To form a lossy transmission line, instead of using a single C_{R} and L_{R}, these capacitances and inductance are distributed as separators between “impulsive sections.” Typically, each value is equal and chosen such that the equivalent capacitance and inductance remain the same as for single components (i.e., each inductor has a value of L_{R}/n and each capacitor has a value of nC_{R}, where n the number of separators used). We define “resonant nodes” 506 as the points between these capacitors and inductors. These resonant nodes can be convenient interface points for adding power as well as data downlink and uplink to an entire impulsive section as discussed below. The voltage amplitude at a resonant node is proportional to L_{R}/C_{R}. Only the phase changes from one resonant node to the next.

A set of reactive strings arranged in this manner can be analysed as a lossy transmission line. Models of, say, a coaxial cable transmission line can be built as a lossy transmission line having capacitance, inductance, and resistance per unit length. A reactive string has discrete components, but can still have characteristics similar to a continuous lossy transmission line for a large network. Reactive strings having no inductors operate synchronously within themselves as long as inductance is negligible: no phase shifts exist within such an “impulsive” portion of a network. However, there is a phase shift as the drive waveform passes through the inductors and capacitors separating impulsive sections.

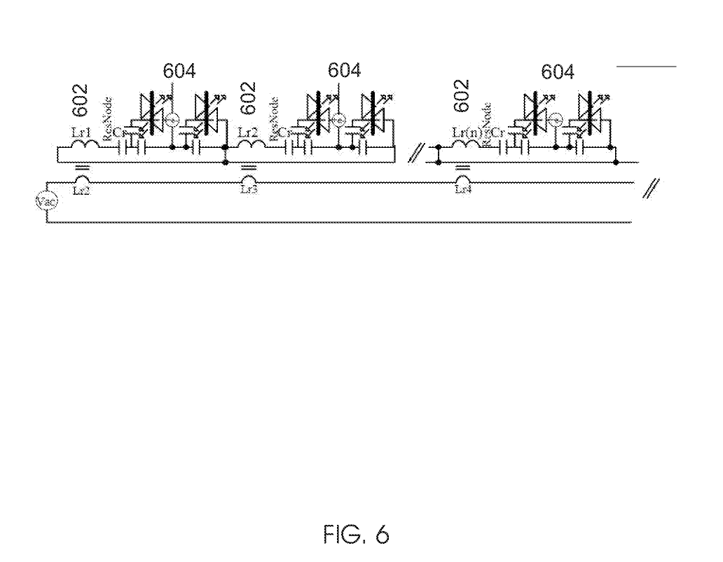

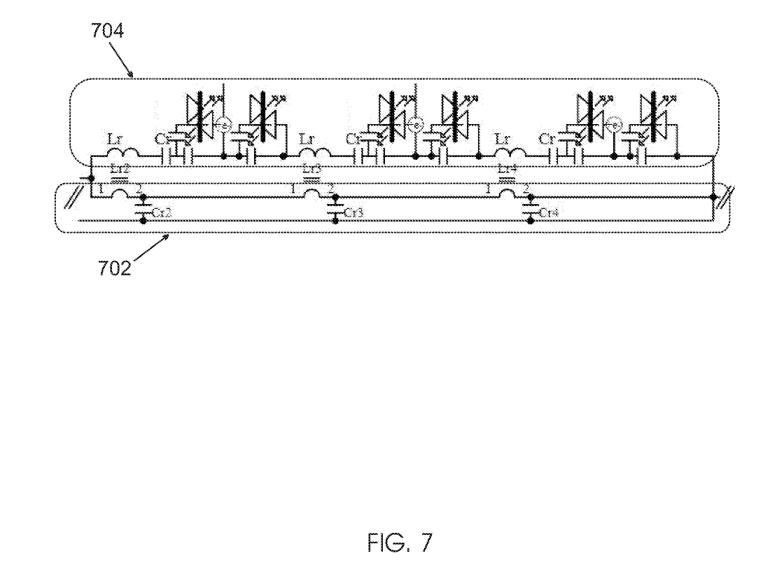

Large sets of reactive strings can be connected together as lossy transmission lines. There is no upper limit on the length of such a lossy transmission line, because one can inject additional power (current) at the appropriate phase as needed at any resonant node along the length of the line. This can be seen conceptually in FIG. 6. The main “line” is implemented as the primary side of a multi-tap transformer. Each secondary 602 provides current to one impulsive section 604. Another example of such power injection is shown in FIG. 7. A separate near-lossless transmission line 702 parallels the lossy transmission line 704. Capacitors Cr2, Cr3 and Cr4 provide matching phase shifts to the phase shifts along the lossy transmission line. In typical embodiments, phase delays between segments of the lossy transmission line are small. The segments are in resonance with only real and parasitic effects. A small lagging phase is used to maintain power injection by power switching components which operate with zero voltage switching. Management of the lagging power energy can be optimal. Transformers Lr2, Lr3, and Lr4 couple current into the lossy transmission line by loose coupling, retaining an overall low primary inductance on the lossless transmission line suitable for high frequency driving. These power injections can be viewed as analogous to the use of repeaters in long-distance data transmission lines (e.g., undersea cables). Spacing repeaters at suitable intervals can reduce the overall voltage levels required to support a long line. Power for the repeaters can be provided using a separate power cable feeding power from a single power source, or a plurality of separate power sources can be used to supply power to each of one or more repeaters.

Lossy transmission line configurations can be advantageous for extended physical geometries such as streetlights along a road or highway. Streetlights interconnected as a lossy transmission line, even over many miles of highway, can form a naturally interconnected set of FSOC communications cells.

At the opposite size extreme, a lossy transmission line can be used to power a very large population of very small lighting elements. These elements may have significant specification variability (V_{frwd}, colour, bandwidth, luminous output, etc.) and may even have a significant percentage failure while continuing to provide useful collective function.

Thus, while RSSL networks are well-suited to driving parallel strings each containing a relatively small serial string, an arbitrary number of such parallel loads can then be conveniently serialised as a lossy transmission line. Such a configuration can be used for any size scale from massive arrays of tiny elements on a single die (COB assembly) to complete industrial work areas, stadium lights, street lights, and so on. FSOC can be added to any of these systems at minimal additional cost.

Adjacent impulsive sections can be used to implement adjacent FSOC communications cells. To avoid optical interference, adjacent cells can have isolated segments each with slightly delayed dark epochs (used for data transfer), with different colour, different data carrier frequencies, or any combination thereof. Full duplex communications can be implemented within each FSOC cell.

Intercellular communications can be implemented via the RSSL network wires, intercell leaked FSOC links, or optical fibres as appropriate to a particular installation. Typically, wires or optical fibres would be appropriate for communications between cells in different rooms or floors within a building, while FSOC links may be preferable between buildings or streetlights.

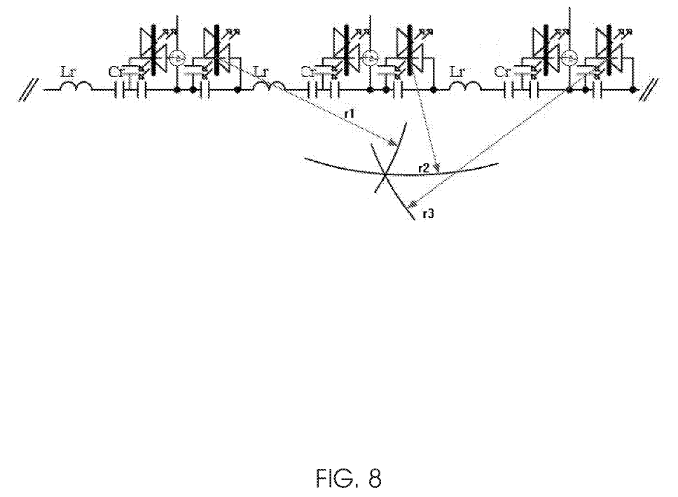

In some embodiments, a lossy transmission line RSSL network can be used to provide precision position and/or force monitoring. A reactive string can function as a “nerve fibre” along a robot arm or wearable device, for example, or more generally within any system where position monitoring is useful. A variety of position transduction methods can be implemented within an impulsive section of a lossy transmission line RSSL network. These methods can be optical, ultrasonic, and/or piezoelectric. One or more capacitors in a reactive string can be implemented as a piezoelectric device. Piezoelectric transducers can be used as strain gauges to measure elongation, compression, or bending. Piezoelectric transducers can also be used as load sensors to detect touch, force, or weight. Piezoelectric transducers can be used as sonic or ultrasonic transducers which can, in turn be used in a variety of ways as are known in the art. The phase shift that exists along a lossy transmission line can be exploited to implement either optical or ultrasonic phased array techniques by detecting the interference from light or sound emitted from different impulsive sections. An optical implementation is illustrated in FIG. 8. Each LED that is in range for position detection determines a range sphere with radius (e.g., r1, r2, and r3), and the intersection point determines a precision location.

RSSL systems provide a superior platform for FSOC compared to prior art systems due to several inherent features. The availability of a dark epoch dramatically improves signal-to-noise by eliminating noise interference from illumination multipath and surface reflection effects. LEDs are autoregulated and autonomously biased so that they are always close to being ready to turn on if they are not already on. One can demonstrate this biasing effect with an unpowered string: a slight disturbance such as touching a node in a reactive string with a probe connected to earth causes the string to “scintillate” whereby sufficient energy is shuttled through the string to cause individual LEDs to flicker alternately. Each LED requires only a slight electrical “nudge” to start to emit light, and as one turns on, an adjacent LED gets a subsequent nudge to trigger a random cascade.

Another remarkable property of RSSL networks is that the ability of the network to passively adapt to the failure of individual elements (either open or short) completely changes the statistical failure characteristics of an array compared to prior art arrays. No zener diodes are required to protect against overvoltage, and it is possible to configure networks that can tolerate up to about 50% failure. The net result is that RSSL network reliability actually improves with scale (number of elements in the network), while prior art systems become more prone to end-of-useful-life failure. Large arrays of under-driven, low-cost and lower power parts can be used to build high luminous output systems with long mean time before failure.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practised without these specific details. In other instances, well known methods, procedures, and components have not been described in detail so as not to unnecessarily obscure aspects of the present embodiments.

What is claimed is:

1. A free space optical communications (FSOC) system comprising
an excitor comprising an electrical waveform generator; and
a first reactor comprising a first resonant circuit;
wherein the first resonant circuit comprises a first plurality of reactive components and a first plurality of lighting elements;
wherein the excitor is configured to drive the first resonant circuit;
wherein the first resonant circuit is under-damped when driven by the excitor;
wherein the electrical waveform generator is operable to generate a first AC voltage waveform at a first frequency between about 10 kHz and about 100 MHz;
wherein a first subset of the first plurality of reactive components determines the power in a first lighting element of the first plurality of lighting elements, and a second subset of the first plurality of reactive components determines the power in a second lighting element of the first plurality of lighting elements;
wherein the lighting elements emit an AC luminous waveform when the first resonant circuit is driven by the excitor,
wherein the AC luminous waveform comprises a first phase and a second phase,
wherein the AC luminous waveform provides general area illumination during the first phase but not during the second phase, and
wherein, during one or both phases, either
the AC luminous waveform is modulated by a datastream or
a resonant circuit comprises a light sensor, and a voltage waveform in the resonant circuit is modulated by light impinging on the light sensor.

2. The system of claim 1, wherein the datastream modulates the first AC voltage waveform.

3. The system of claim 1, wherein the datastream modulates a second AC waveform having a second frequency different from the first frequency.

4. The system of claim 1, further comprising a sensor or control,
wherein the sensor or control is operable to manage the power in the first lighting element and the second lighting element, and
wherein a bi-directional datastream flows between the electrical waveform generator and the sensor or control.

5. The system of claim 1, further comprising a first optical sensor, a first optical emitter, and a user communications device, the user communications device comprising a second optical sensor and a second optical emitter,
wherein the first optical emitter is operable to transmit a downlink datastream to the second optical sensor, and
wherein the second optical emitter is operable to transmit an uplink datastream to the first optical sensor.

6. The system of claim 5, wherein the first optical emitter comprises the first lighting element or the second lighting element.

7. The system of claim 5, wherein the first optical emitter is distinct from the first lighting element and the second lighting element.

8. The system of claim 7, wherein the first optical emitter emits light at wavelengths that are distinct from wavelengths emitted by the first lighting element or the second lighting element.

9. The system of claim 7, further comprising a second reactor comprising a second resonant circuit,
wherein the second resonant circuit comprises a second plurality of reactive components and a second plurality of lighting elements;
wherein the excitor is configured to drive the second resonant circuit;
wherein the second resonant circuit is under-damped when driven by the excitor;
wherein a first subset of the second plurality of reactive components determines the power in a first lighting element of the second plurality of lighting elements, and a second subset of the second plurality of reactive components determines the power in a second lighting element of the second plurality of lighting elements; and
wherein the first optical emitter is part of the second plurality of lighting elements.

10. The system of claim 5, wherein the first optical emitter is modulated by a variable reactive component.

11. The system of claim 10, wherein the variable reactive component comprises a piezoelectric device.

12. The system of claim 10, wherein the variable reactive component comprises a surface acoustic wave (SAW) device.

13. The system of claim 9, further comprising one or more separator reactive elements, wherein the first reactor and the second reactor are separated by the one or more separator reactive elements such that a phase delay exists in the first AC waveform between the first reactor and the second reactor.

14. The system of claim 13, wherein a datastream is added or extracted at a node located at one of the one or more separator elements, such that data is transmitted or received by the lighting elements of either the first reactor or the second reactor but not both.

15. The system of claim 13, further comprising a current injection system whereby AC current at the first frequency can be injected at a node located at one of the one or more separator elements.

16. The system of claim 1, wherein one or more of the first plurality of lighting elements or the first plurality of reactive components is configured to sense position or force and the resulting position or force data is transmitted over a power bus providing power to the first plurality of lighting elements.

17. The system of claim 16, wherein one or more of the first plurality of reactive components is a piezoelectric device, configured to sense position or force.

18. The system of claim 16, wherein the sensing of position or force uses a phased array detection method and two or more lighting elements or reactive components.

19. The system of claim 1, wherein two or more of the first plurality of lighting elements are located on a single die cut from the wafer on which the lighting elements were fabricated.

20. The system of claim 19, wherein the single die further comprises two or more of the first plurality of reactive elements.
